(19) United States
(12) Patent Application Publication
(10) Pub. No.: US 2025/0174140 A1
(43) Pub. Date: May 29, 2025

(54) Apparatus and Method for Teaching Financial Responsibility

(71) Applicant: Ayriel Jones, Beaumont, CA (US)

(72) Inventor: Ayriel Jones, Beaumont, CA (US)

(21) Appl. No.: 18/520,420

(22) Filed: Nov. 27, 2023

(51) Int. Cl. G09B 5/00; G06Q 10/1053; G06Q 40/02; G06Q 40/12

(52) U.S. Cl. CPC G09B 5/00; G06Q 10/1053; G06Q 40/02; G06Q 40/12

(57) ABSTRACT

An apparatus and method for teaching students financial responsibility. There is a computing system configured with an application that mimics a banking system including a local kiosk for student interactive inputs. Entry and all reporting transactions are geared for young students and requires only presentation of a cart to a kiosk and two clicks. The system differs from a real bank because all of the deposits and withdrawals are based on classroom actions of the student that are tied to various values of credits, positive or negative. It also allows the purchase of goods with credits in the student's account log. The student can also apply for classroom jobs through the bank. Thus the system teaches responsible wage earning, banking, online purchasing, and online job application in a system that is audited by the teacher and augmented by counselling sessions.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to formal education classes, and more particularly to an apparatus and method for administering a program of financial responsibility development.

### BACKGROUND

The level of personal debt established by poor financial responsibility in the USA is at an all-time high. Credit card debt averages $7,951 per household based on 2022 data from the Federal Reserve and the U.S. Census Bureau. This is the average level of debt that remains unpaid at all times. Obviously, most Americans are living beyond their means.

For instance, 18- to 29-year-olds have the highest credit card delinquency rates. According to the NY Fed., at least 8.8% were 90-plus days behind on payments, up from 8.5% the previous quarter. Further, in a recent study by Quicken, 35% of Americans said they believed they would max out at least one of their credit cards by the end of the year, regardless of their income level.

While there can be a plethora of mitigating factors (such as divorce, loss of job, illness, unexpected auto/home repairs), the reason this phenomenon is most severe with young adults, can only be attributed to poor financial responsibility. This in turn is largely due to the fact that financial responsibility is not taught in most curriculums. Even where educational programs on finances are taught, they are not being taught in a meaningful way such that the student can identify and internalize the teachings. There lacks a link between these financial responsibility teachings and what the student takes away and uses in their life.

Prior art systems try to use computerized systems running applications for the recording of the student's classroom performance but these require numerous inputs from the teacher. These just increase the teacher's workload and do nothing to teach the student financial and classroom responsibility. Other computerized systems are too complex for younger children and require a lot of scrolling about and data entries such that errors are common and it discourages students because of the time it takes. With their shorter attention spans, a much simpler system is necessary.

There must be some way that a young adult can learn responsible financial spending habits before hitting a hard wall of consumer debt brought on by irrational credit card use. The “crash and burn” approach is an unnecessary and painful entry into the adult world of conspicuous consumption.

Henceforth, an educational program that teaches young student's financial responsibility and is modeled closely to the real world financial transactions these students will eventually encounter, would fulfill a long felt need in the world of education. This new invention utilizes and combines known and new technologies in a unique and novel configuration to overcome the aforementioned problems and accomplish this. As such, a more controllable and consistent program for teaching personal financial responsibility is provided by the embodiments set forth below.

### BRIEF SUMMARY

In accordance with various embodiments, a method of teaching financial responsibility to young students is provided that has a simplistic visual user interface with an ID system that launches the student into a quick, simple two click system of reporting.

In one aspect, a real world, day-to-day operational system for classroom operations tied to a financial framework that students undergo the entire school year while in the classroom, is provided.

A program that allows students to establish their own spending/earning habits in a recordable format that is to be reviewed with the student and system administrator (teacher) on an ongoing basis.

In another aspect, a year-long financial education program for students, integrated with their daily classroom transactions, for which each student garners the rewards and suffers the repercussions for their financial decisions.

A program with an application on a computing system that tracks each student's actions/financial decisions and performs the accounting for each student's financial log on a computing system with but the presentation of a QR code and input of two clicks at a kiosk. The computing system allows for immediate updated, real time log viewing by the student of only their financial log but allows the system administrator viewing access to all student's financial logs.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a block diagram representation of the apparatus used to teach financial responsibility;

FIG. 2 is a flow chart of the steps of the method for teaching financial responsibility;

FIG. 3 is a picture of the portal access means of the preferred embodiment (a personal ATM Card);

FIG. 4 is a screen capture of the portal (kiosk screen) after the portal has been opened;

FIG. 5 is a is a screen capture of the deposit (credit) screen;

FIG. 6 is a screen capture of the withdraw (debit) screen;

FIG. 7 is a screen capture of the reward center screen;

FIG. 8 is a screen capture of the reward center showing items for purchase;

FIGS. 9 and 10 are a screen captures of the job application screens; and

FIG. 11 is a screen capture of an accounting log; and

FIG. 12 is a suggested class schedule for the implementation of the system.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments.

Reference will now be made in detail to embodiments of the inventive concept, examples of which are illustrated in the accompanying drawings and charts. In the following detailed description, numerous specific details are set forth to enable a thorough understanding of the inventive concept. It should be understood, however, that the described examples are provided for illustrative purposes and are not intended to limit the scope of the invention.

Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the following description, for the purposes of explanation, numerous specific details are set forth in order to provide a thorough understanding of the described embodiments. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

As used herein, the term “portal” refers to a gateway or entry point into a transactional reporting and recording software application that is accessible through or on a LAN or WAN computing system. It is also referred to as a “kiosk” as it is a dedicated personal computer in the preferred embodiment.

As used herein, the term “personal computing device” refers to multi-purpose microcomputers, computer tablets, cellular phones, microprocessors, personal digital assistants and the equivalent.

As used herein the term “portal access means” refers to the element that allows a student to unlock the portal and enter into the interactive, specific personalized transactional log and accounting ledger in a dedicated application on or accessible via a computing system. It may be a physical element such as a card, token, fob or the equivalent with a magnetic chip or stripe, or a scannable visual code/image (bar code, QC code or the equivalent) input through a video interface at the portal on the kiosk. It may be a username/password manually input through a keyboard, touch pad, touch screen, mouse or microphone into video interface, and input/output interface ports. Lastly, it may be directives received from another machine, interaction with a virtual reality (VR) environment, biometric feedback, or other input signal.

As used herein the term “system administrator” refers to the person overseeing the program's day to day operation and administration. In the preferred embodiment this is the classroom teacher for the school, although on a larger scale this could be a remote, dedicated operator.

As used herein, the term “data input means” comprises any means selected from the group consisting of keyboards, mice, tactile (touch) pads, touch screens, microphones processing verbal commands, roller balls and buttons.

As used herein, the term “application” refers to the overall program or sets of logic steps grouped into modules that direct a computing system to perform specific functions, the total of which operates the portal access, data input, transactional recording, the accounting, purchasing, debit, credit and employment modules, and visual presentation The application is housed on and run by a computing system. The software application may be housed on a local computer system or on a remote server accessible via the internet.

As used herein, the term “services” refers to actions or lack of actions provided by the teacher (hence the term “services”) that a student may undertake, such as not having to do a book report, being able to go to recess early and the like.

As used herein, the term “module” refers to a functional block physically implemented by computing systems comprising electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the modules being implemented by microprocessors or similar, they may be programmed using software (e.g., microcode) to perform various functions discussed herein and may optionally be driven by firmware and/or software. Alternatively, each module may be implemented by dedicated hardware, or as a combination of dedicated hardware to perform some functions and a processor (e.g., one or more programmed microprocessors and associated circuitry) to perform other functions. Also, each module of the embodiments may be physically separated into two or more interacting and discrete modules without departing from the scope of the inventive concepts. Further, the modules of the embodiments may be physically combined into larger, more complex modules without departing from the scope of the inventive concepts. In the present system “modules” are groupings of logic steps and instructions that direct a computing system to perform specific functions in a related area such as banking, employment, purchasing, kiosk operation, etc.

As used herein, the term “click” refers to a selection of an option presented on the visual display of a kiosk. The click is a single action of a data input means to select a selectable option displayed on the kiosk. This click may be by a single touch of a touch screen, keystroke of a data input device such as a keyboard, press of a mouse or the like.

The following discussion is intended to provide a brief, general description of a suitable computing system/s in which certain aspects of the inventive concept can be implemented. Typically, the computing system/s include a system bus to which is attached processors, memory, e.g., random access memory (RAM), read-only memory (ROM), or other state preserving medium, storage devices, a video interface, and input/output interface ports. The computing system/s can be controlled, at least in part, by input from conventional input devices, such as keyboards, mice, etc., as well as by directives received from another machine, interaction with a virtual reality (VR) environment, biometric feedback, scan codes/images, or other input signal. As used herein, the term “computing system” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc.

The computing system can include embedded controllers, such as programmable or non-programmable logic devices or arrays, Application Specific Integrated Circuits (ASICs), embedded computers, smart cards, and the like. The computing system can utilize one or more connections to one or more remote computing systems, such as through a network interface, modem, or other communicative coupling. Computing systems can be interconnected by way of a physical and/or logical network, such as an intranet, the Internet, local area networks, wide area networks, etc. One skilled in the art will appreciate that network communication can utilize various wired and/or wireless short range or long-range carriers and protocols, including radio frequency (RF), satellite, microwave, Institute of Electrical and Electronics Engineers (IEEE) 545.11, Bluetooth®, optical, infrared, cable, laser, etc.

Embodiments of the invention may include a non-transitory computing system readable medium comprising instructions executable by one or more processors, the instructions comprising instructions to perform the elements of the embodiments as described herein.

Embodiments of the inventive concept can be described by reference to or in conjunction with associated data including functions, modules, procedures, data structures, application programs, etc. which when accessed by a computing system results in the computing device performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for computing system access.

The present invention relates to a novel design for a financial responsibility educational program used on a daily basis in the classroom to teach and develop financial responsibility integrated with classroom behavior in the young students. It is designed for young students in elementary school—with grade four as the target with 9 year old students. At the target age the complexity of the computer interactions at the kiosk and bank must be simplified. The target is to teach financial responsibility/student behavior that ties together banking, on-line purchasing, employment, decision making and accountability for their day to day classroom actions. The system must be quick so all the class can be processed quickly, without input from the teacher and essentially error free. Thus the kiosk (the portal access means and data input means) for the computing device along with the software application, performs a key role in the successful operation of the system.

The system is not to teach how to navigate around a banking application or kiosk (although some of this is inherent). For this reason, the screens are grossly simplified and require but the selection of select few option boxes that are configured to input the action (responsible or not) and the associated credit value. The students thus have to admit to the full wording of the option box without waiver or downplaying. For example, a student that has to make a withdrawal because they did not take a proper action has only six option box selections. One of those is “did not do my homework” and a deduction of $3 worth of the credits shown in their accounting log. There is no explanation, no excuses and no partial punishment. It is a simple decision based on the criteria set forth. Was the entire homework finished and submitted on time-Yes or No. Similarly other options include: I did not charge my computer, I did not follow the classroom code, I need to use the restroom, I forgot to bring my computer, and I need to buy tools (replacement for lost glue, pencils etc.) Much of what it teaches children is that the world is not a forgiving place, especially when it comes to one's finances. Hence the reason for only having selectable options at the kiosk. The only variable inputting is for the mini resume the student put in when applying for classroom jobs.

One of the reasons that young adults on their own encounter problems with their finances and life in general, is because they have been allowed to cite excuses to partially mitigate their actions up until that point. Paying back a $10 loan to their father a week late with excuses may be acceptable, but paying a credit card after the due date will cause interest at a phenomenally high rate, or missing rent will get one evicted. This system attempts to remedy this problem by teaching children accountability (financial and otherwise) at an early age. Keeping the selectable options tersely worded with no room for excuses and associating penalties that they can seem immediately in their accounts has proven to alter their financial and classroom habits.

However, in the way the program/system is designed it also begins introducing computerized banking, on line purchasing, and on line job seeking to young children and more importantly, how these things all intersect in one's life in the real world. Possibly the system/program would aptly be named “life lessons 101.” It does not function merely as a bank or a credit reporting and accounting system, rather it sets a test environment where the student after reporting their actions and credits, are offered preset options that act as behavioral reinforcers that continually test what they are being taught. As the student builds credits, they encounter options that reinforce their actions and that also will test their rational actions at another level. For example, if they continue making responsible actions through proper classroom actions they are tempted with rewards which can be purchased with their credits. Instant gratification of reward purchases of foolish things will lower their credit level such that they may not have enough credits to purchase larger rewards as they become available. Thus while they learned responsibility in earning credits they may not have learned responsibility in purchasing actions. Similarly, they may learn the benefits of having several jobs to earn credits when they have spent or lost their credit balances or when they are saving up for a special reward. They can learn hard work will get them out of a financial jam or allow them to bank for future rewards. The system seeks to teach the previous things focusing on reinforcement over the school year and thus simplifies the operation of the teaching system with the simple two click input approach.

As can be seen, the system is an interactive one that teaches financial responsibility from numerous levels including continued earning, responsible action behavior, responsible spending, delayed gratification, additional employment and proper employment habits. All this is done from a simple kiosk with a two click system of reporting.

The program (system) has a transactional reporting and accounting application on a computing system that is accessible through a public kiosk with a portal access means, each student's personal computing device or the system administrator's personal computing device. The application is configured to allow the kiosk in its await state, to scan the presentation of a QR coded card to open a first menu screen with five selectable options two successive screens each with a limited number of selectable options allows which leads to a second screen with another different set of selectable options. This system thus requires but two clicks for a student to record their actions, purchase a reward or apply for a job. From the third screen displayed, they may input the goods or services they wish to purchase (which is recorded) and the associated costs (debits) are taken from the student's account balance. Similarly, from this third screen, the student may input work they have done or rewards they have garnered, and the associated payment (credits) will be recorded and accounted for in the same fashion. An ongoing accounting is performed on the debits and credits of the student. Each student's account will be viewable at any time by the student or system administrator. The teacher will review these on a periodic basis with each student and provide financial counselling as needed. Additionally, from this third screen they may apply for upcoming jobs and be notified thereof. After a brief preset period of inactivity, the application reverts the kiosk back to its await state. It is to be noted that if the student just wants to view their account credit balance they need only scan their QR code and with one click select the view account selectable option.

This simple three screen and two click system allows students to log their classroom behavior, purchase a reward, apply for a job or view their account balances is the most expedient manner.

Educational studies, especially in the area of juvenile criminal offenses, show that a major factor in the commission of juvenile crimes is that they fail to comprehend the severity of the consequences of their actions. This ongoing educational program is intended to provide continual, instantaneous feedback to the student of the consequences of their financial actions in an attempt to foster or engender responsible spending habits. This, coupled with a year-long series of individual recurring, financial counseling sessions tailored to the reported decisions in their account, is intended to establish financially responsible students.

The system teaches more than financial responsibility as many of the withdrawals/debits are tied to bad decisions of the student such as failing to hand in homework, not charging their classroom computer, losing their classroom tools (pencils, markers, paper, tape etc.), needing excessive restroom visits to name a few. Other debits come from purchasing items from the classroom store such as extra classroom tools or rewards, homework passes and the like. Credits come from doing extra jobs around the classroom, exhibiting exemplary behavior or performing exceptionally well in classroom work. Since the student's account balances can rise or fall, they get immediate feedback from their decisions and actions (or lack thereof). Overall, students can see in real time what the effects of their day to day efforts and decisions are. It is intended to foster financial responsibility and good banking habits, as well as teaching student the benefits of hard work, attention to details, personal property responsibility and the long term benefits of continually making wise decisions vs the pitfalls of instant gratification.

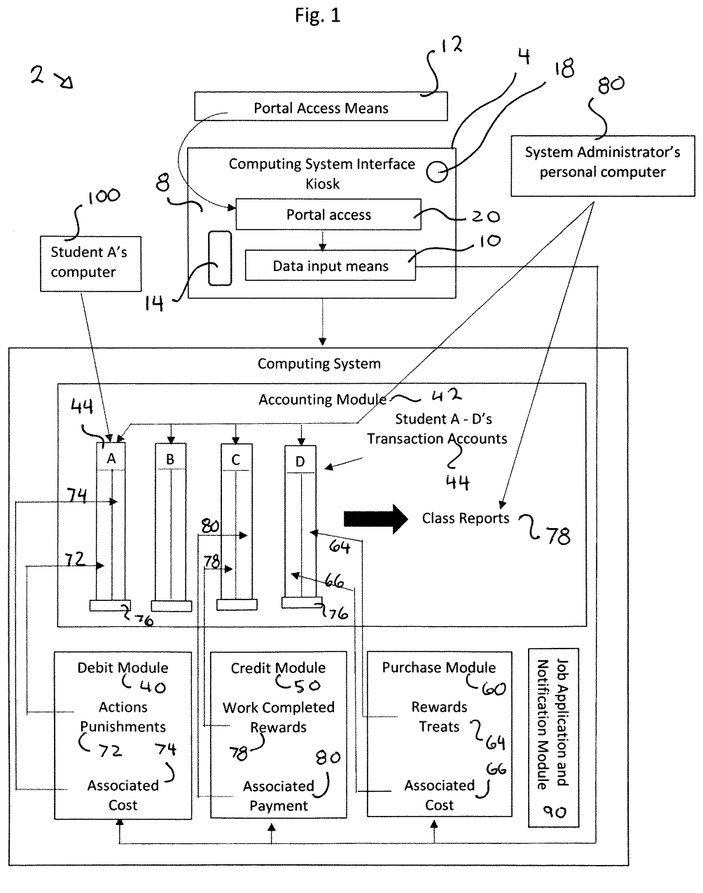

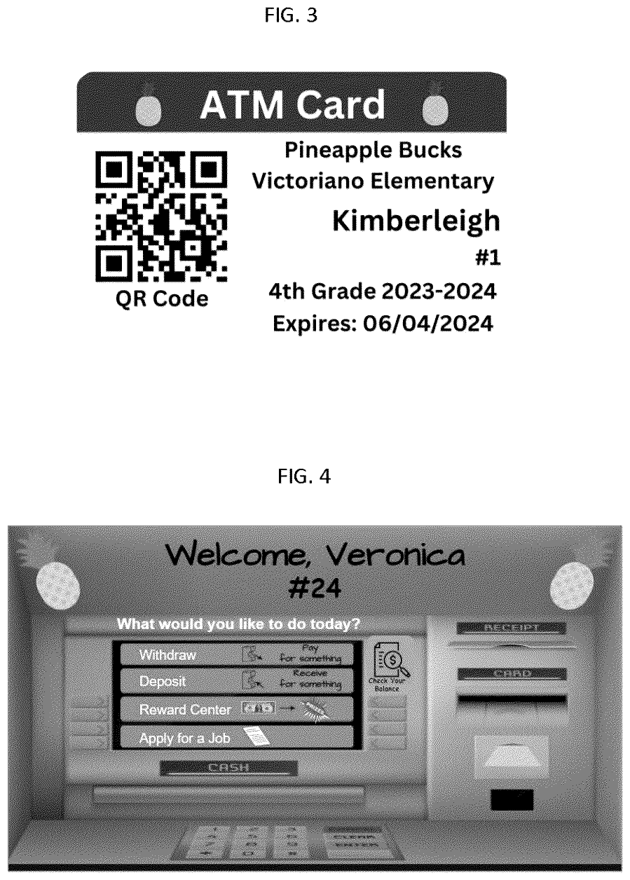

Looking at FIG. 1 it can be seen that the system for teaching financial responsibility 2 is comprised of an interface kiosk 4 that has a portal access scanning device 14, a visual display 8, a microphone 18 and a data input means 10 each operationally connected to a computing system 6 and its associated transactional recording and accounting application modules 40, 42, 50, 60, 90. There is a discrete portal access means 12 given to each student that allows a student access to the various transactional modules of the application when presented (via scanning, keyboard entry or spoken word) to the portal access 20. The portal access is a system entry module 20 of the application that has the kiosk remain in a await state that is awakened upon visual presentation of a student's QR code. Once it has received a data input from a portal access means 12 and has validated its authenticity such that the user is indeed permitted to use the application, it then displays a screen on the visual display 8 of the kiosk (or on the visual display of the students' or system administrator's computing device 100 and 80) that allows access to the other five modules of the application on the computing system. In the preferred embodiment the interface kiosk 4 is a personal computer, the scanning device 14 sending data to the portal access means 12 is a camera, the data input means 10 is a keyboard and track pad/mouse, and the portal access means 12 is a card bearing the student's identifiers and a scannable QR code 16. (See FIG. 3.) From this point on, a transaction requires either one or two clicks (mouse click, keyboard click or touch on a touch screen) to complete the student's transaction. The application modules send the selections to the accounting module which records the transaction and tabulates the credits of each student's account log.

Looking now at the methodology/operation of the preferred embodiment of the system 2, the student presents their portal access means 12 to the awaiting scanning device 14 (camera) of the kiosk 4 which inputs the QR code data on the face of the portal access means 12 to the portal access module 20 of the application present on the computing system. Upon presentation of a registered portal access means 12 to the kiosk 4, the portal access module 20 opens the application, presenting that student's individualized options screen 26 onto the visual display 8 of the kiosk 4. (In alternate embodiments a password entry from the data input means or spoken command into the microphone could accomplish this same function of unlocking the application.) The system 2 is now ready for transactional selection and input.

Looking at FIG. 4 it can be seen that the application provides a student initial options screen 26 with five selectable options 28, 30, 32, 34 and 36. Each option is processed through a module (functional block of instructions) of the application and is initialized with a single click. The first three options are transactional options and mimic real world adult financial transactions but the actions are geared toward a student's classroom life. These options are:
Withdraw 28 (debit module)
Deposit 30 (credit module)
Reward Center 32 (purchase module)
Apply for a Job 34 (employment module)
Check your Balance 36 (accounting module)

An option is selected by the student with click on the data input means 10. If withdraw 28 is selected, the debit module 40 displays the withdraw screen 70 shown in FIG. 6 on the kiosk visual display 8. This provides six additional selections 72 for actions/conduct of the student in the classroom that reflect poor decisions. Each of these actions 72 are also selected with a single click of the data input means, and have a financial debt 74 associated with it, based on the severity of the penalty administered to the student for their actions. For example, not doing homework has a $3 penalty, while having to replace missing pencils, erasers etc. has a $2 penalty and requiring an extra restroom break has a $1 penalty. The student selects the applicable selection/s 72 using the data input means 10.

Once selected, the debit module 40 provides this data of the action and the associated costs to the accounting module 42 which inputs these (as well as the transaction date from the real time clock of the computing system) into the student's accounting log 44. This accounting log 44 records the date, the student's action, the value of the penalty and tabulates a running balance 76 of the money in the student's account.

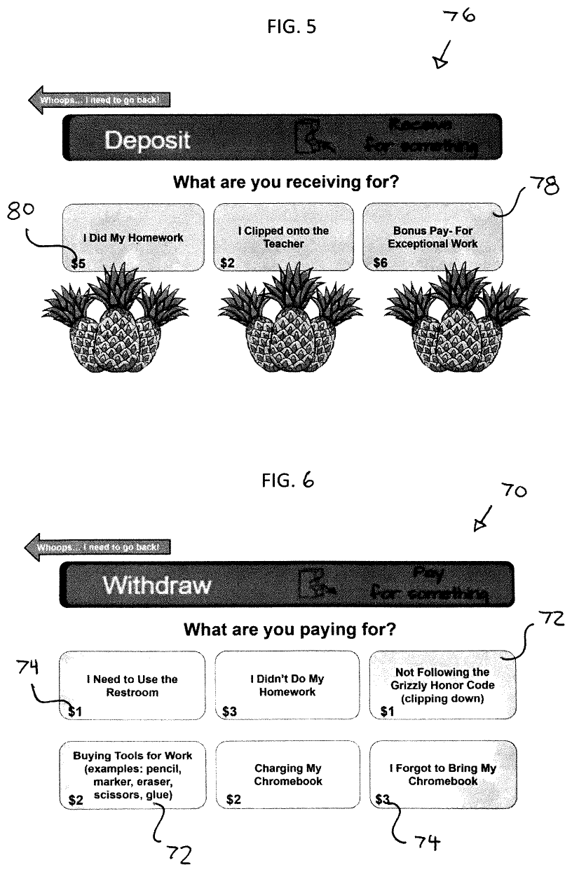

If the option the student selects is deposit 30, the credit module 50 displays the deposit screen 76 shown in FIG. 5 on the kiosk visual display 8. This provides three additional selections 78 for actions/conduct of the student in the classroom that reflect good decisions and can be input with a click. Each of these actions 78 have a financial credit 80 associated with it, based on the size of the reward administered to the student for their exemplary actions. For example, doing homework gives $5, while exceptional work garners $6. The student selects the applicable selection/s 78 using the data input means 10.

Similar to the debt module 40 above, once selected, the credit module 50 provides this data of the action and the associated credit to the accounting module 42 which inputs these (as well as the transaction date from the real time clock of the computing system) into the student's accounting log 44 with a single click. This accounting log 44 records the date, the student's action 78, the value of the payment 80 and tabulates a running balance 76 of the money in the student's account.

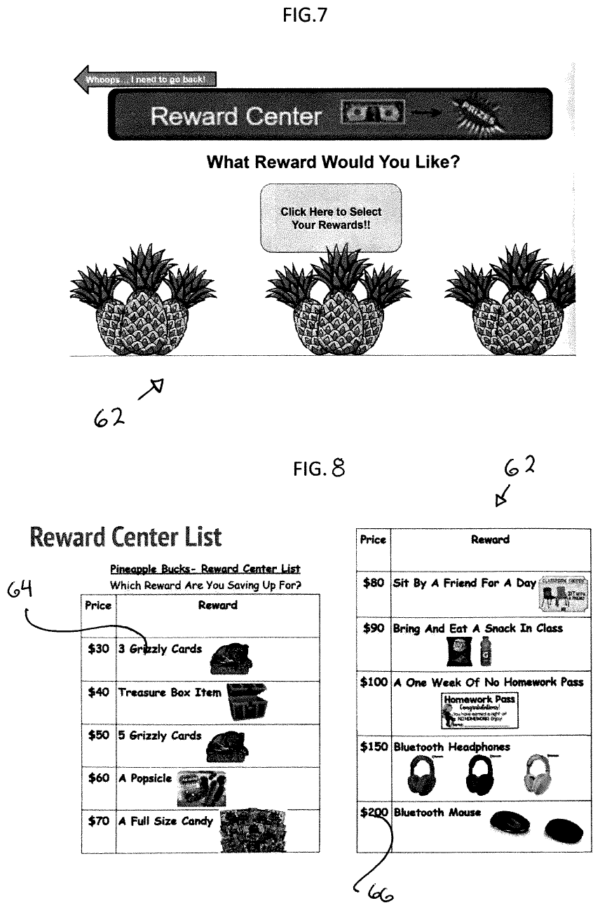

The student may also choose the third transactional option-which is the reward center 32. This causes the purchase module 60 to display the reward center screens 62 shown in FIGS. 7 and 8 on the kiosk visual display 8. This provides numerous purchase selections 64 the student can buy with one click if they have enough money in their accounts. These rewards are continually updated and changed with the rewards varying greatly in value and applicability to a student. They may vary from an edible treat, to being able to sit by a friend for a day to a set of headphones. Each selection has an associated cost 66, based on the size of the good or service. For example, a popsicle costs $60 while sitting by a friend for a day costs $80. The items for purchase may be goods or actions, such as not having to hand in a book report. The student selects the applicable selection/s 64 at that time, using the data input means 10.

Similar to the debt and credit modules 40 and 50 above, once selected, the purchase module 60 provides this data of the purchase and the associated cost 66 to the accounting module 42 which inputs these (as well as the transaction date from the real time clock of the computing system) into the student's accounting log 44. This accounting log 44 records the date, the student's purchase 64, the cost 66 and tabulates a running balance 76 of the money in the student's account.

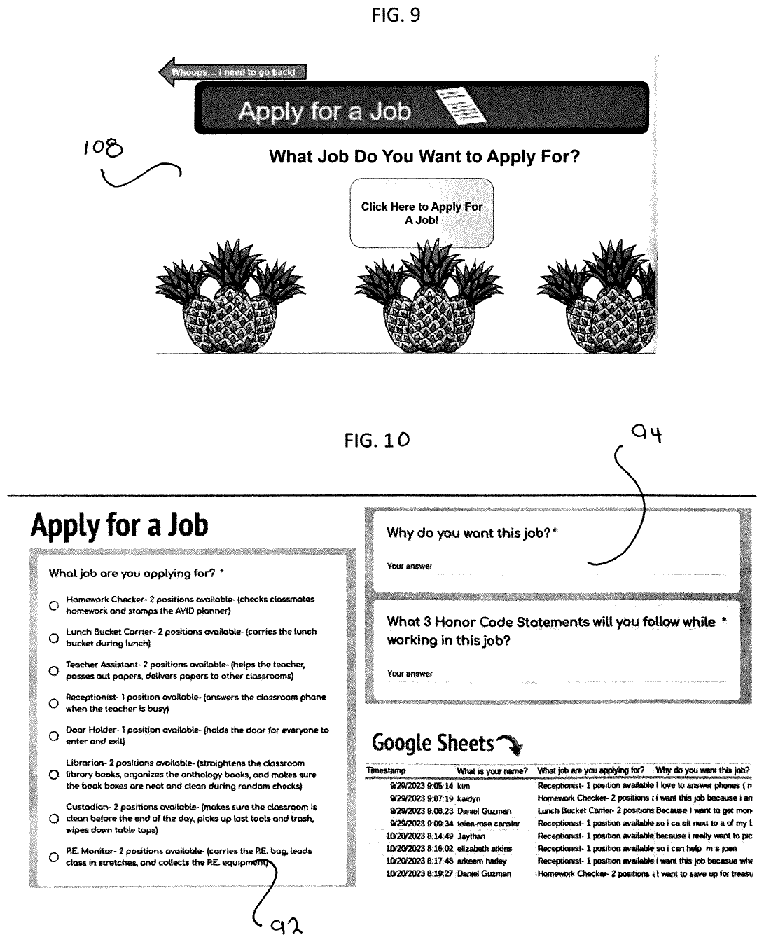

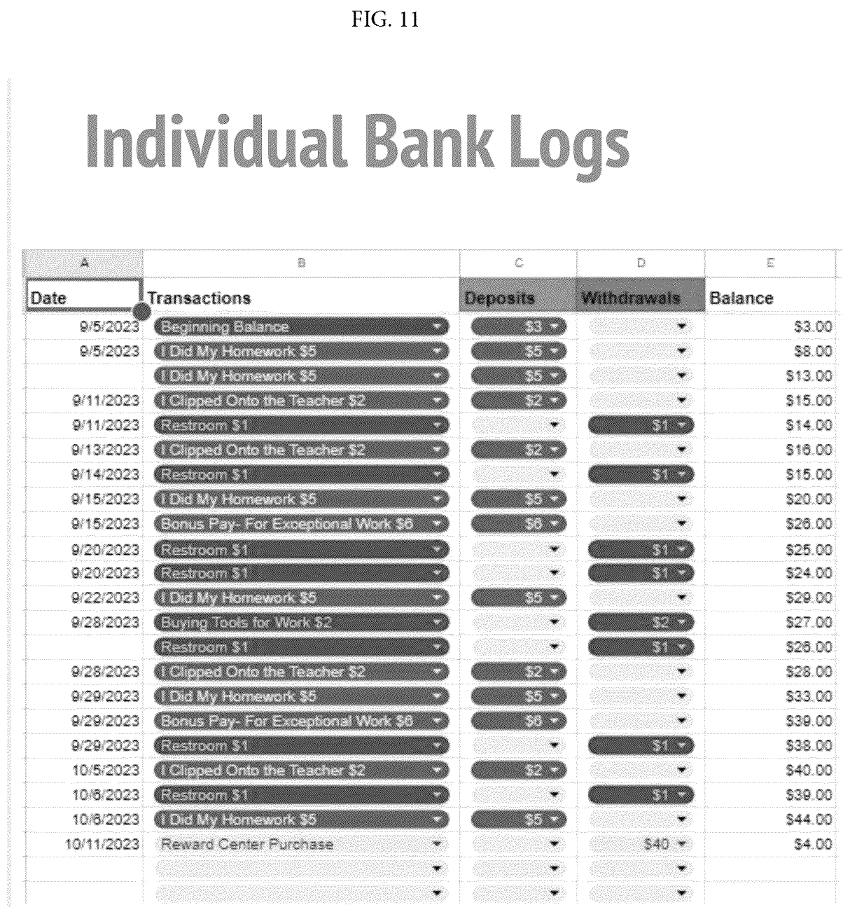

Lastly, like an adult may supplement their income by taking a second job, there is a there is an option for the student to earn extra money by doing tasks around the classroom. This option is enacted by clicking the apply for a job option 34 which causes the employment module 90 to brings up the screen 108 of FIG. 9. This brings up a selectable list of immediately open jobs 92 as well as an area for the student to input a “mini resume” 94 where they state why they want the job and what classroom ethics they will use in performing the job. The system administrator will decide on the employment. Payment for performing the jobs are put in the deposit screen 30 and the credit module 50 processes the recording of this as discussed above. The jobs will be continually updated and will vary in responsibility, pay and required time to complete. Hopefully here children will learn the rewards and sacrifices of taking on extra work. For example while a job cleaning the blackboards and brushes may increase their credit accounts, it also may mean they can't play a sport at recess with their friends. Their employment may be necessary to supplement a negative credit balance or may help them get a larger reward they don't have enough credits for.

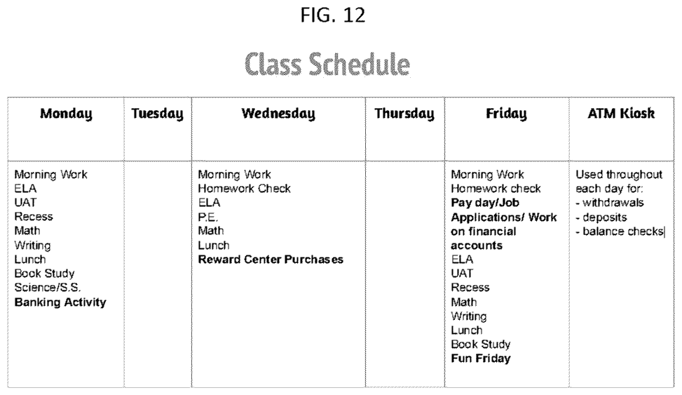

Use of the system 2 is regulated by a class schedule 110 that sets forth the applicable times for use of the various banking activities. (See FIG. 12) Since each student's input may be done quickly with a min of one click and a maximum of two clicks, this process is a quick way for the teach to be able to have all the student's data input as well as a way for the student to begin learning responsibility of their financial and classroom actions. It is a huge advance in data recording for simple systems.

The system is supplemented by student audits by the teacher wherein the student's accounting log 44 is accessed and reviewed by the teacher with the student present. The teacher provides feedback whether it be constructive criticism, praise, suggestions, etc. to keep the students on the track to future financial well-being.

The accounting module 42 also can generate classroom reports 78 that are accessible by the system administrator 80. Each student may select the “Check your Balance” option 36 from the initial options screen 26 which will allow the accounting module 42 to display the accounting log 44 at the kiosk.

This system is intended to mimic conventional banking practices, and the kiosk represents an ATM machine of a bank. However, the students may access the application through their own computing device 100 as well which mimics mobile banking.

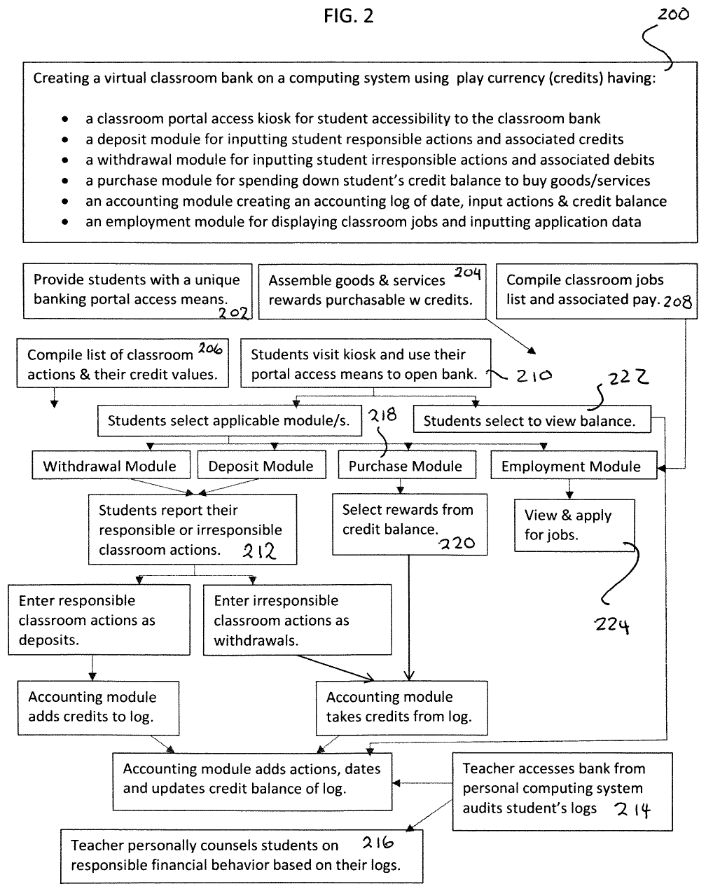

Looking at FIG. 2, the method steps for teaching financial responsibility to students in a classroom setting are as follows:
1. Creating a virtual classroom bank on an accessible computing means using play currency (credits), the computing means having a banking application with: a classroom portal access kiosk for student accessibility to the classroom bank, a deposit module for inputting student responsible actions and associated credits, a withdrawal module for inputting student irresponsible actions and associated debits, a purchase module for spending down student's credit balance to buy goods/services, an accounting module creating an accounting log of date, input actions & credit balance, and an employment module for displaying classroom jobs and inputting application data in the form of a mini resume. 200
2. Providing students with a unique banking portal access means. 202
3. Establishing a bank account for each of said students, said bank accounts having an account log;
4. Assembling a set of one click selectable options of goods and services rewards that can be purchased with credits with input to purchase module. 204
5. Assembling a list of one click selectable options for classroom actions and their associated credit values with input to the withdrawal module and the deposit module. 206
6. Assembling a list of one click selectable options for classroom jobs and their associated pay with input to the employment module. 208
7. Performing an ongoing routine of the following steps:
8. Visiting kiosk by student and using of their portal access means to open the virtual classroom bank. 210 (In the preferred embodiment this will be a individual scannable QR code card presented to the awaiting kiosk scanner/camera.)
9. Selecting which selectable options from the list of preset of modules the student wishes to see or enter data into. (In the preferred embodiment this will be the first click selection.)
9. Inputting by student of student's classroom actions into the available selectable options in the withdraw or the deposit module. 212 (In the preferred embodiment this will be the second click option selecting from a group of selectable options.)
10. Optionally, accessing the purchase module 218 and selecting options of the rewards, paying with credits from account balance. 220 (In the preferred embodiment this will be the second click option selecting from a group of selectable options.)
11. Optionally, accessing the employment module to review and select the options to apply for available classroom jobs. 224 (In the preferred embodiment this will be the second click option selecting from a group of selectable options.)
12. Accessing and viewing of students account balance by student. 222
13. Viewing and auditing student's account logs by teacher.
14. Conducting personal financial responsibility counselling sessions by teacher with each student. 216
15. Changing the selectable options for goods and services and their values, on a regular basis.
16. Changing the selectable options for jobs and their values, on a regular basis.
17. Changing the selectable options for withdrawal and their debits, on a regular basis.
18. Changing the selectable options for deposit and their credits on a regular basis.

The use of this system 2 has had a series of unexpected results. First, because of its operational simplicity at the kiosk, students are doing it, not skipping it, and doing it with little or no teacher input or error reporting. Second, not only have the students begun to show financial responsibility, student accountability, goal setting, increased homework completion, better attendance and classroom behavior. With the continual changing of classroom actions, rewards and jobs, the complexity of making rational financial decisions is everchanging and tests the children to a higher degree. It is thus an ongoing evolving educational exercise/platform that grows as the students' ability to make better financial decisions increases. There are two main technological improvements that have led in large part to the program's success. First, the fixed option selection with no possibility of not accepting the consequences for the outcome of their actions. Second, the increasing difficulty or complexity of the financial decision making for the child as the selectable options for rewards, actions and jobs change.

As stated earlier much of the success of this system is its improved, simplified user interface at the kiosk. Prior art interfaces had many drawbacks relating to the efficient functioning of the application on the computing system, requiring the young student to move around the screens and switching views to find the right module as well as having to report their action in consistent language without error reporting of credit values, not to mention the amount of time it would take a classroom to be processed one at a time through the kiosk. Prior art applications were geared for older students and had their data and functionality divided into numerous screens. Their prior art interfaces required students to drill down through many screens to get to the proper module and accomplish their data entry/purchase/etc. The one and two click system with a kiosk awaiting presentation of an identifying portal access means that then brought up a complete options menu with preset module selections that upon click brought up the desired module with a one click option is simple, quick and leads to error free reporting for very young students. The option for modifiable module options allows the system to grow along with the students responsibility selections.

While certain features and aspects have been described with respect to exemplary embodiments, one skilled in the art will recognize that numerous modifications are possible. Moreover, while the elements and method for building and assembling and using the system described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. A method for teaching students financial responsibility through the use of a virtual classroom bank, comprising the steps of:
creating a virtual classroom bank on a computing system, with an application having;
a deposit module for inputting responsible actions of a student and their associated credits,
a withdrawal module for inputting irresponsible actions of a student and their associated debits,
an accounting module that creates an accounting log with a date, said input actions and a balance of said student's associated credits, and
establishing a bank account for said student, said bank account having said accounting log;
establishing a classroom portal access kiosk for student accessibility to said classroom bank;
providing students with unique banking portal access means;
assembling a list of classroom actions and their associated credit values and inputting said list of classroom actions to said withdrawal module and said deposit module;
presenting visually student's said banking portal access means by student at said portal access kiosk to open said virtual classroom bank to allow access and present the module selection screen;
using a first click to select a selectable option;
inputting student's classroom actions by student, into the withdraw or the deposit module with a second click;
accessing and viewing of students accounting log by student;
viewing and auditing student's accounting logs with student's credits by teacher;
conducting personal financial responsibility counselling sessions by teacher with each student based on their said student accounting log and said student credits.

2. The method for teaching students financial responsibility through the use of a virtual classroom bank of claim 1, further comprising the step of:
creating a purchase module in said application for spending down said student's credits to buy rewards;
assembling a set of rewards that can be purchased with said student's credits and inputting said set of rewards to said purchase module;
accessing and viewing said purchase module by student and optionally purchasing said rewards with said student credits and a second click.

3. The method for teaching students financial responsibility through the use of a virtual classroom bank of claim 1, further comprising the steps of:
creating an employment module in said application for displaying classroom jobs and inputting application data;
compiling a list of classroom jobs and their associated pay and inputting said list to said employment module;
accessing and viewing said employment module by student and optionally applying for jobs with a second click.

4. The method for teaching students financial responsibility through the use of a virtual classroom bank of claim 1, further comprising the steps of:
creating an employment module in said application for displaying classroom jobs and inputting application data;
compiling a list of classroom jobs and their associated pay and inputting said list to said employment module;
accessing and viewing said employment module by student and optionally applying for jobs.

5. An apparatus for teaching a student financial responsibility comprising:
an interface kiosk that has a portal access scanning device;
a computing system with transactional recording and accounting application modules;
a classroom portal access kiosk for said student accessibility to said classroom bank with a visual display; a microphone; a data input means, said kiosk operationally connected to said computing system;
a portal access means that when presented at said kiosk, allows said student access to the transactional recording and accounting application modules with a single first click;
wherein there are the following transactional recording modules;
a deposit module for inputting responsible actions of said student and a first associated credit amount from a set of selectable options, with a single second click,
a withdrawal module for inputting irresponsible actions of said student and a second associated credit amount from a set of selectable options, with a single second click,
an accounting module that creates an accounting log with a date, said responsible and said irresponsible actions, and a balance of all of said student's associated credit amounts, and that is accessible with the proper selection of the module upon said single first click.

6. The apparatus for teaching a student financial responsibility of claim 5 further comprising another transactional recording module; a purchase module for spending down said student's credits to buy rewards for credits from a set of selectable options, with a single second click; and
wherein said accounting log also has any said rewards purchased with said student's credits spent.

7. A method for teaching students financial responsibility through the use of a virtual classroom bank on a computing system comprising the steps of:
establishing an account for said student;
establishing a classroom portal access kiosk for student accessibility to said virtual classroom bank;
providing students with a unique scannable QR code on an ATM card;
accessing said classroom bank and said account by student through said portal access kiosk by scanning said ATM card;
inputting into said computing system by student, their irresponsible classroom actions and an associated credit amount;
inputting into said computing system by student, their responsible classroom actions and an associated credit amount;
allowing students to select rewards for purchase from their credits;
creating an accounting log for student including said student's input responsible and irresponsible classroom actions and associated credit values, a date of said inputting, said reward purchases and spent credits, and a sum of said credits;
accessing and viewing of student's accounting log by student;
accessing and auditing student's accounting log by teacher;
conducting personal financial responsibility counselling sessions by teacher with each student based on said student accounting log and said student credits.
